(19) United States
(12) Patent Application Publication
(10) Pub. No.: US 2024/0344003 A1
(43) Pub. Date: Oct. 17, 2024

(54) FILMS AND CAPSULES

(71) Applicant: Conopco Inc., d/b/a UNILEVER, Englewood Cliffs, NJ (US)

(72) Inventors: Maria Fernanda Jimenez Solomon, Wageningen (NL); Andrew Philip Parker, Wageningen (NL)

(73) Assignee: Conopco Inc., d/b/a UNILEVER, Englewood Cliffs, NJ (US)

(21) Appl. No.: 18/683,805

(22) PCT Filed: Aug. 25, 2022
(86) PCT No.: PCT/EP2022/073735

§ 371 Date: Feb. 15, 2024

(30) Foreign Application Priority Data
Aug. 27, 2021 (EP) 21193588.7

(51) Int. Cl. C11D 17/04; C08J 5/18; C11D 11/00

(52) U.S. Cl. CPC C11D 17/045; C08J 5/18; C11D 11/00; C08J 2305/00; C08J 2305/06; C08J 2429/04

(57) ABSTRACT

A water-soluble capsule comprising a water-soluble film and at least one internal compartment enclosed by the water-soluble film, the compartment having an internal space and containing a home care composition within the internal space, where film comprises a comprises a polysaccharide having:
(i) an average molecular weight in the range 100K-1000K g/mol;
(ii) one or more functional groups comprising one or more of a sulfate, sulfonate or a carboxylate group or any combination thereof; and
wherein branching side chains comprising four or more units are present at a maximum of one side chain for every four units of the backbone;
and wherein the film thickness is from 40 to 200 micrometres (microns).

The present invention relates to bio-based capsules of water-soluble film for containing homecare substrate treatment compositions. In particular, the invention relates to bio-based capsules which have processability and performance.

Bio based films are desirable alternative to current PVOH based films. However, making films which can be formed and stretched into deep, high volume capsules and filled with aggressive cleaning chemicals which do not dissolve in the hand or leak in use is a major challenge. Despite the prior art there remains a need for bio-based films whilst still having processability and performance.

Accordingly, and in a first aspect, there is provided a water-soluble capsule comprising a water-soluble film and at least one internal compartment enclosed by the water-soluble film, the compartment having an internal space and containing a home care composition within the internal space, where film comprises a comprises a polysaccharide having:
(i) an average molecular weight in the range 100K-1000K;
(ii) one or more functional groups comprising one or more of a sulfate, sulfonate or a carboxylate group or any combination thereof; and
wherein branching side chains comprising four or more units are present at a maximum of one side chain for every four units of the backbone;
and wherein the film thickness is from 40 to 200 micrometres (microns).

The applicant has surprisingly found that water-soluble capsules made from films with comprising polysaccharides which are tuned by co-selection average molecular weight, branching and functionalisation in combination with a film thickness range as claimed provides an improved bio-based water-soluble film which can be formed and stretched into deep, high volume capsules (to contain sufficient cleaning chemicals for a consumer washing load), and with precisely the right balance of dissolution and strength such that capsules do not dissolve too quickly in the hand or leak but which will dissolve quickly once in a wash liquor.

The following terms, as used here are defined below:

“A” and “an”, are understood to mean one or more of what is claimed or described.

“Alkyl” refers to a straight or branched chain monovalent hydrocarbon radical having a specified number of carbon atoms. Alkyl groups may be unsubstituted or substituted with substituents that do not interfere with the specified function of the composition and may be substituted once or twice with the same or different group. Substituents may include alkoxy, hydroxy, mercapto, amino, alkyl substituted amino, nitro, carboxy, carbonyl, carbonyloxy, cyano, methylsulfonylamino, or halogen, for example. Examples of “alkyl” include, but are not limited to, methyl, ethyl, n-propyl, isopropyl, n-butyl, s-butyl, t-butyl, n-pentyl, n-hexyl, 3-methylpentyl, and the like.

“Biodegradable” means the complete breakdown of a substance by microorganisms to carbon dioxide water biomass, and inorganic materials.

“Film” refers to a water-soluble material and may be be sheet-like material. The length and width of the material may far exceed the thickness of the material, however the film may be of any thickness.

“Polymer” refers to a macromolecule comprising repeat units where the macromolecule has a molecular weight of at least 1000 Daltons. The polymer may be a homopolymer, copolymer, terpoymer etc.

“repeating unit” refers to the repeating unit of the backbone of the polysaccharide and may comprise a monosaccharide but may also be a disaccharide or even larger repeat units.

“Substrate” mean any suitable substrate including fabric articles or garments, bedding, towels etc., and dishes, where “dishes” is used herein in a generic sense, and encompasses essentially any items which may be found in a dishwashing load, including crockery chinaware, glassware, plasticware, hollowware and cutlery, including silverware.

“Thermoforming” means a process in which the film is deformed by heat, and in particular it may involve the following: a first sheet of film is subjected to a moulding process to form an enclosure in the film e.g. forming a recess in the film. Preferably this involves heating prior to deformation. The deformation step is preferably enabled by laying the film over a cavity and applying a vacuum or an under pressure inside the cavity (to hold the film in the cavity). The recesses may then be filled. The process may then include overlaying a second sheet over the filled recesses and sealing it to the first sheet of film around the edges of the recesses to form a flat sealing web, thus forming a capsule which may be a unit dose product. The second film may be thermoformed during manufacture. Alternatively, the second film may not be thermoformed during manufacture.

“Substrate treatment composition” means any type of treatment composition for which it is desirable to provide a dose thereof in a water-soluble and is designed for treating a substrate as defined herein. Such compositions may include, but are not limited to, laundry cleaning compositions, fabric softening compositions, fabric enhancing compositions, fabric freshening compositions, laundry prewashing compositions, laundry pretreating compositions, laundry additives (e.g., rinse additives, wash additives, etc.), post-rinse fabric treatment compositions, dry cleaning compositions, ironing aid, dish washing compositions, hard surface cleaning compositions, and other suitable compositions that may be apparent to one skilled in the art in view of the teachings herein.

“Unit dose” means an amount of composition suitable to treat one load of laundry, such as, for example, from about 0.05 g to about 100 g, or from 10 g to about 60 g, or from about 20 g to about 40 g. A unit dose product may be in the form of a film package containing the composition, the package may be referred to as a capsule or pouch.

“Water-soluble” means the article (film or package) dissolves in water at 20° C.

Unless otherwise noted, all component or composition levels are in reference to the active portion of that component or composition, and are exclusive of impurities, for example, residual solvents or by-products, which may be present in commercially available sources of such components or compositions.

Except in the examples and comparative experiments, or where otherwise explicitly indicated, all numbers are to be understood as modified by the word “about”.

All percentages (expressed as “%”) and ratios contained herein are calculated by weight unless otherwise indicated. All conditions herein are at 20° C. and under the atmospheric pressure, unless otherwise specifically stated.

Unless otherwise specifically noted all polymer molecular weights are determined by weight average molecular weight (MW).

Numerical ranges expressed in the format “from x to y” are understood to include x and y. When for a specific feature multiple preferred ranges are described in the format “from x to y”, it is understood that all ranges combining the different endpoints are also contemplated. In specifying any range of values or amounts, any particular upper value or amount can be associated with any particular lower value or amount.

### Molecular Weight (MW)

The weight average molecular weight (MW) is in the range 100,000 (100K)-1000,000 (1000K) g/mol.

Capsules made from films having a weight average molecular weight (MW) below 100,000 (100K) g/mol dissolve too quickly and there is a risk that it will dissolve in the user's hand. Capsules made from films having a weight average Molecular weight (MW) in the range 100,000 (100K)-1000,000 (1000K) g/mol dissolve more slowly and in combination with the provision of functional groups (such as sulfates, sulfonates, carboxylates) provide good dissolution.

High molecular weight films do not have the required dissolution characteristics, even with functionalisation by sulfate etc groups.

### Branching

Branching of the polysaccharide is limited such that ‘long’ branching side chains i.e. those comprising four or more units, are present at a maximum of one side chain for every four units of the backbone, preferably every 8 units, more preferably every 16 units.

The polysaccharide may be linear.

### Functional Groups

The polysaccharide is functionalised in that it comprises one or more of a sulfate, sulfonate or a carboxylate group or any combination thereof.

Preferably, the or each functional group is attached to a sugar unit of the polysaccharide backbone or to a side chain. The functional groups may be present naturally but may also be added chemically.

Chemical sulfation may be achieved by any suitable means e.g. using K₂SO₄, SO₃— pyridine and SO₃—Me₃N complexes (all available from Sigma Aldrich).

Chemical sulfonation may be achieved by any suitable means e.g. sodium 3-chloride-2-hydroxy-propyl sulphonate (CHPS) as sulfonating reagent.

The polysaccharide at least preferably from 10%-50% functionalised, that is to say it comprises 0-50% sulfate, sulfonate or carboxylate or mixtures thereof.

### Degree of Functionalisation (Number of Functional Groups).

Suitably, the polysaccharide comprises at least 1, more preferably at least 2, even more preferably at least 3 said functional groups per repeating unit of the polysaccharide.

Suitably the polysaccharide comprises no more than 5, preferably no more than 4 said functional groups per repeating unit.

Suitably, the number of sulfate groups is selected from the range of 1-4, preferably 2-3 said functional groups per repeating unit.

In a particular preferred embodiment, the functional group is a sulfate. In embodiments, the number of sulfate groups is one, such as Lambda carrageenan.

The functional groups may be linked by ester bonds to sugar moities, e.g. to hydroxyl groups of the sugar units of the polysaccharides.

### Further Functional Groups.

Further functional groups may be present, preferably one or more amine groups. The degree of amidation (DA) is expressed as a percentage of amidated repeating units to total repeating units in the polysaccharide. molecule. Preferably the degree of amidation is from 2% to 25%, most preferably from 20 to 25%.

### Film Thickness

The film thickness (before incorporation into a product e.g. capsule) is from 40 to 200 micrometres (microns). This combined with the polysaccharide characteristics described herein, provides for a film that is strong enough to withstand handling especially when it contains quantities of a home care composition but that also dissolves in water during aqueous washing processes in which that home care composition is used.

Preferably the film thickness is from 40 to 150 micrometres (microns), more preferably from 60 to 90 micrometres (microns), most preferably from 70 to 80 micrometres (microns).

In embodiments, the film may have a thickness (before incorporation into a product e.g. capsule) from 151-200 micrometre, preferably from 160-200, more preferably from 170-200 micrometre.

Water-soluble capsules may be made using two films, e.g one (second) film superposed over another (first) film and sealed around edge regions e.g. as described herein. Where two films are used to make a capsule, the second film is typically of a similar type to that used for the first film, but slightly thinner. Thus, in embodiments, the second film is thinner than the first film. In embodiments the ratio of thickness of the first film to the thickness of the second film is from 1:1 to 2:1.

In embodiments the first film thickness (pre-thermoforming) is preferably from 40 to 200 micrometres, from 40 to 150 micrometres, from 60 to 120 micrometres, or from 80 to 100 micrometres. After capsule manufacture the average thickness of the first film is preferably from 30 to 90 micrometres, or from 40 to 80 micrometres.

In embodiments the second film thickness (pre-thermoforming) is preferably from 20 to 100 micrometres, from 25 to 80 micrometres, or from 30 to 60 micrometres.

### Layer

Preferably the film comprises a single layer, that is to say it comprises no more than one layer. One way this may be achieved is that the film is made by forming a solution of carrageenan with a solvent e.g. water and any other ingredients (plasticisers, bittering agent as examples) and this is then cast e.g. poured on to a surface such as a moving belt and then dried. Preferably, no further layers of the film are added by casting.

Preferably, the water-soluble capsule of the invention comprises film having a single layer.

### Polysaccharides

The polysaccharide may be selected from carrageenan, pectin, alginate, (fungal) chitosan cellulosic or any combination thereof.

### Chitosan Film

The film may comprise chitosan. Chitosan is a naturally non-sulfated and linear polysaccharide, however it may be sulfated or sulfonated by chemical means.

Chitosan is preferably sourced from fungi.

However, the film may be substantially free of chitosan, that is to say less than 5% wt, preferably less than 1% wt and most preferably 0% chitson based on total weight of the film.

### Carrageenan Film

The film may comprise carrageenan.

Carrageenan is the generic name for a family of linear, sulfated galactans, obtained by extraction from a certain species of marine red algae (Rhodophyta). Carrageenans are composed of alternating 3-linkedb-D-galactopyranose (G-units) and 4-linkeda-D-galactopyranose (D-units) or 4-linked 3,6-anhydrogalactose (A-units), forming the disaccharide repeating unit of carrageenans (see FIG. 1). The sulfated galactans are classified according to the presence of the 3,6-anhydrogalactose on the 4-linked residue and the position and number of sulfate groups.

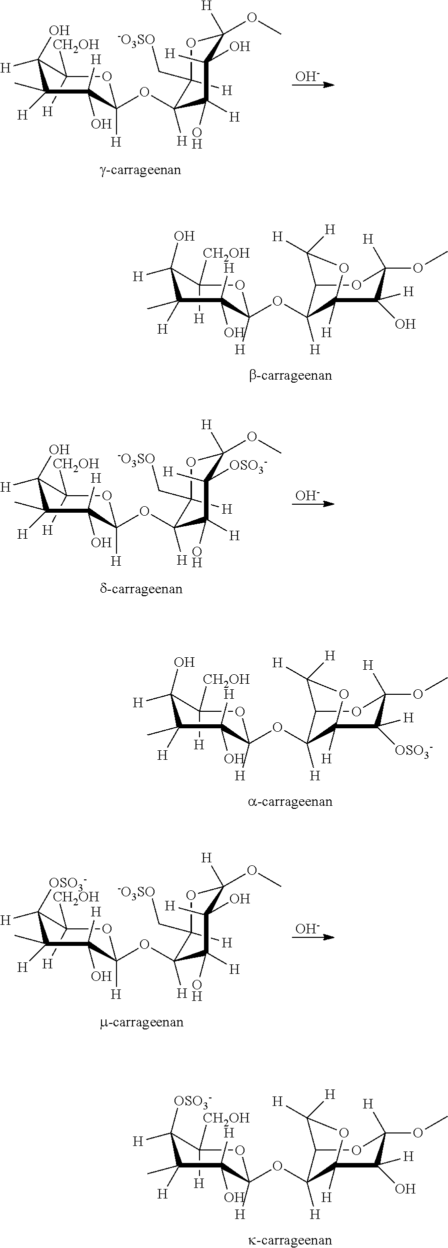

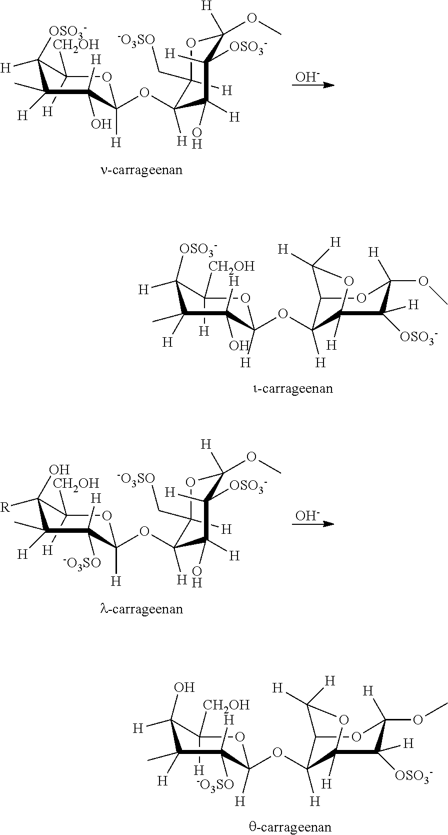

The carrageenan may in any of the above forms i.e. alpha (α)-, beta (β)-, Iota (i)-, Kappa (k)-, Lambda (λ)-, Mu (μ)-, Nu (v)-, gamma (γ)-, Delta (δ)- or Theta (Θ)-carrageenan.

k-Carrageenan is predominantly obtained by extraction of the tropical seaweed Kappaphycus alvarezii, known in trade as Eucheuma cottonii (or simply cottonii) (Rudolph, 2000). Eucheuma denticulatum (trade name Eucheuma spinosumor simply spinosum) is the main species for the production of i-carrageenan. The sea-weeds are usually extracted with alkali at high temperatures to transform the biological precursors μ and v-carrageenans into commercial k- and i-carrageenans.

λ-carrageenan is obtained from different species of the Gigartina and Chondrus genera.

Preferably the film comprises at least 10% wt>20% wt>30% wt>50% wt>70% wt carrageenan (% wt based on total dry (cast) weight of the film). In other words, preferably, the film comprises at least 10% wt, more preferably at least 20% wt, even more preferably at least 30% wt, still more preferably at least 50% wt most preferably 70% wt carrageenan (% wt based on total dry (cast) weight of the film).

Preferably the film comprises less than 90% wt>80&wt of the film (% wt based on total dry (cast) weight of the film).). In other words, preferably the film comprises less than 90%, more preferably less than 80% wt carrageenan (% wt based on total dry (cast) weight of the film).

### Lambda (λ) Carrageenan

The film preferably comprises lambda (λ) carrageenan.

Preferably the film comprises at least 10% wt more preferably at least 20% wt even more preferably at least 30% wt still more preferably at least 50% wt most preferably at least 70% wt (λ) lambda (λ) carrageenan (% wt based on total dry (cast) weight of the film).

Alternatively the film comprises more than 10% wt preferably more than 20% wt even more preferably more than 30% wt still more preferably more than 50% wt most preferably more than 70% wt lambda (λ) carrageenan (% wt based on total dry (cast) weight of the film).

Preferably the film comprises no more than 60% wt more preferably no more than 70% wt even more preferably no more than 80% wt most preferably no more than 90% wt lambda (λ) carrageenan (% wt based on total dry (cast) weight of the film).

In embodiments, the lambda carrageenan may be present in the range 10-90% wt, preferably 20-85% wt., more preferably 40-80% wt, most preferably 50-80% wt (% wt based on total weight of the carrageenan present in the film).

### Pectin Film

The film may comprise pectin.

The pectin may comprise one or more galacturonans including heterogalacturonans, substituted galacturonans, rhamnogalacturonan I pectins (RG-I), rhamnogalacturonan II (RG-II)s or any mixture thereof.

Preferably the pectin is amidated.

The pectin may comprise any proportion of D-galactopyranosyluronic acid residues in α-(1→4) linkage, the carboxyl groups of which may be esterified to any degree by methyl groups or may be partially or completely converted into salts. The esterification level may be such that the pectin is a high methoxy pectin (HM pectin)—with more than half of all the galacturonic acid esterified; or a low methoxy pectin (LM pectin) with less than half of all the galacturonic acid esterified. Preferably the degree of methoxylation is from 1% to 49%, more preferably from 25% to 48%, most preferably from 24 to 35%.

Preferably the pectin is a low methoxy pectin.

More preferably the pectin is a low methoxy, amidated pectin.

The degree of amidation (DA) is expressed as a percentage of amidated galacturonic acid units to total galacturonic acid units in the molecule of pectin. Preferably the degree of amidation is from 2% to 25%, most preferably from 20 to 25%.

Pectins may be sourced from any suitable source such as citrus peel or pomace from e.g., both by-products of fruit production. Pomace may also be obtained from sugar beet.

### Alginates

The film may comprise alginates.

Alginates are polysaccharide linear copolymers composed of (1→4) linked β-mannuronic acid (M) and its C-5 epimer α-I-guluronic acid (G) units shown below (1) and (II) by glycosidic linkages forming homopolymeric (MM- or GG-blocks) and heteropolymeric sequences (MG blocks).

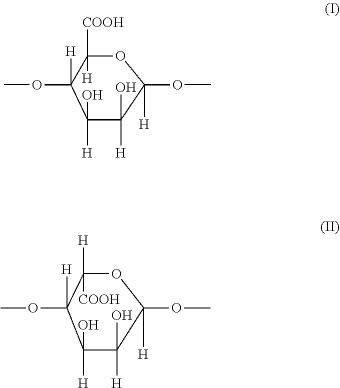

(1) β-1,4-D-mannuronate (mannuronate) and (II) α-1,4-L-guluronate (guluronate)

The alginate may be amidated. By “amidated alginate” it is intended to mean that the alginate is modified by conversion of a portion of the carboxylic groups to carboxylic acid amide.

The degree of amidation (DA) for alginate may be calculated from measuring the C, H and N content (% m/m) by organic elemental analysis on for example, an Elementar vario EL III (Elementar, Germany). The degree of amidation (DA, mol %) of the final products can be calculated based on the carbon (C) and nitrogen (N) contents (% m/m) according to the following formula:

$$\\ DA = \frac{N \cdot 12 \cdot 6}{C \cdot n \cdot 14 - N \cdot c \cdot 12} \times 100 ,$$

where n and c are the numbers of the corresponding elements in the amine molecule. The calculations are based on the assumption supported by FTIR analysis that at the end of the reactions, all the initial methyl ester groups are hydrolysed or substituted by amine.

Preferably the degree of amidation is from 1% to 90%, more preferably from 10 to 70% most preferably from 20 to 60%.

Amidated alginate can be prepared by converting alginate into its acid form followed by methyl esterification of the alginic acid (algin) followed by amino-dealkoxylation with an amidation reagent e.g. n-butylamine, n-hexylamine, n-octylamine, ethylenediamine or ethanolamine.

The units of the alginate compound may be arranged in any manner, i.e., in random or block arrangement. Any alginate compound may be utilized in the compositions of the present invention. For example, the alginate compound may be a naturally occurring alginate compound (naturally occurring alginates may, for example, be derived from seaweed). As used herein, the term “naturally occurring” with respect to the alginate compound means that the alginate compound utilized is found in nature or is prepared synthetically, but chemically equivalent to an alginate compound found in nature. Other alginate compounds which may be utilized include those which are derivatives of naturally occurring alginates, for example, a propylene glycol alginate. Preferably, the alginate compound utilized herein is a naturally occurring alginate.

Preferably, the alginate compound is low in mannuronic acid units relative to guluronic acid units. Specifically, the ratio (by number of units, not by weight of units) of mannuronic acid units to guluronic acid units is preferably less than about 1, more preferably from about 0.1 to about 0.9, and most preferably from about 0.1 to about 0.5.

A preferred alginate compound for use in the present compositions is sodium alginate. Sodium alginate is commercially available from a variety of sources including, for example Sigma-Aldrich CAS no. 9005-38-3.

The alginate may be sourced from brown algae but it may bacterial alginate, e.g. from the bacteria of the genera Pseudomonas and Azotobacter which produce alginates as exopolysaccharides.

### Cellulose

Preferably, the cellulose derivative is selected from hydroxypropyl methyl cellulose, methyl cellulose, hydroxypropyl cellulose, alkali-metal carboxymethyl cellulose,

### PVOH

The film may comprise polyvinyl alcohol (PVOH). The PVOH may be present at a maximum level of 50% wt, preferably at maximum of 25%, (% wt based on total dry (cast) weight of the film).

Advantageously the film is substantially free of polyvinyl alcohol (PVOH). By “substantially free” it is mean that the film is less than 5% wt, even more preferably less than 1% and most preferably 0% wt, (% wt based on total dry (e.g. cast) weight of the film).

### Additives

The water-soluble film can contain other auxiliary agents and processing agents, such as, but not limited to, plasticizers, plasticizer compatibilizers, surfactants, lubricants, release agents, fillers, extenders, cross-linking agents, antiblocidng agents, antioxidants, detackifying agents, antifoams, nanoparticles such as layered silicate-type nanoclays (e.g., sodium montmorillonite), bleaching agents (e.g., sodium metabisulfite, sodium bisulfite or others), and other functional ingredients, in amounts suitable for their intended purposes. Embodiments incluifing plasticizers are preferred. In embodiments, the water-soluble film includes a surfactant, an antioxidant, a bittering agent, a soil release polymer, an anti-redeposition aid, a chelant, a builder, a perfume, or combinations thereof. The amount of auxiliary agents can be up to about 50 wt. %, 20 wt %, 15 wt %, 10 wt %, 5 wt. %, 4 wt % and/or at least 0.01 wt. %, 0.1 wt %, 1 wt %, or 5 wt %, individually or collectively.

### Plasticisers

A plasticizer is a liquid, solid, or semi-solid that is added to a material (usually a resin or elastomer) making that material softer, more flexible (by decreasing the glass-transition temperature of the polymer), and easier to process. A polymer can alternatively be internally plasticized by chemically modifying the polymer or monomer. In addition, or in the alternative, a polymer can be externally plasticized by the addition of a suitable plasticizing agent. Water is recognized as a very efficient plasticizer for PVOH and other polymers; including but not limited to water-soluble polymers, however, the volatility of water makes its utility limited since polymer films need to have at least some resistance (robustness) to a variety of ambient conditions including low and high relative humidity. The plasticizer can include, but is not limited to, glycerin, diglycerin, sorbitol, ethylene glycol, diethylene glycol, triethylene glycol, dipropylene glycol, tetraethylene glycol, propylene glycol, polyethylene glycols up to 400 MW, neopentyl glycol, trimethylolpropane, poly ether polyols, sorbitol, 2-methyl-1,3-propanediol (MPDiol(R)), ethanolamines, and a mixture thereof. A preferred plasticizer is glycerin, sorbitol, triethyleneglycol, propylene glycol, dipropylene glycol, 2-methyl-1,3-propanediol, trimethylolpropane, or a combination thereof.

The total amount of the non-water plasticizer can be in a range of about 10 weight percent to about 40 weight percent, or about 15 weight percent to about 35 weight percent, or about 20 weight percent to about 30 weight percent, for example about 25 weight percent, based on total film weight. Combinations of glycerin, dipropylene glycol, and sorbitol can be used. Optionally, glycerin can be used in an amount of about 5 wt percent to about 30 wt percent, or 5 wt percent to about 20 wt percent, e.g., about 13 wt percent. Optionally, dipropylene glycol can be used in an amount of about 1 weight percent to about 20 weight percent, or about 3 weight percent to about 10 weight percent, for example 6 weight percent. Optionally, sorbitol can be used in an amount of about 1 wt percent to about 20 wt percent, or about 2 wt percent to about 10 wt percent, e.g., about 5 wt percent. The specific amounts of plasticizers can be selected in a particular embodiment based on desired film flexibility and processability features of the water-soluble film. At low plasticizer levels, films may become brittle, difficult to process, or prone to breaking. At elevated plasticizer levels, films may be too soft, weak, or difficult to process for a desired use.

In some embodiments the plasticizer can include glycerin, sorbitol, and trimethyloyl propane. Optionally, the plasticizer can be included in an amount greater than or equal to 30 phr, or greater than 40 phr, for example in a range of about 30 phr to about 75 phr, about 30 phr to about 70 phr, about 30 phr to about 60 phr, about 30 phr to about 50 phr, or about 30 phr to about 45 phr.

In some embodiments, the plasticizer can include glycerin, sorbitol, and 2-methyl-1,3-propanediol. Optionally the plasticizer can be included in an amount less than 30 phr or less than 25 phr, for example in a range of about 5 phr to about 30 phr, about 10 phr to about 30 phr, about 15 phr to about 30 phr, about 5 phr to about 29 phr, about 5 phr to about 25 phr, about 10 phr to about 25 phr, or about 15 phr to about 25 phr.

The plasticizer preferably comprises a polyol.

Preferred plasticizers include glycerol, diglycerol, sorbitol, ethylene glycol, diethylene glycol, triethylene glycol, dipropylene glycol, tetraethylene glycol, propylene glycol, polyethylene glycols up to 400 MW, neopentyl glycol, trimethylolpropane, poly ether polyols, sorbitol, 2-methyl-1,3-propanediol (MPDiol(R)), ethanolamines, and a mixture thereof.

Preferably, the polyol comprises glycerol or a sugar alcohol e.g. sorbitol or a polymeric polyol up to 400 MW, such as PEG 400 or any mixture thereof. The inventors have found that when glycerol, D-Sorbitol and PEG 400 are combined with carrageenan film, no additional plasticizers are needed, i.e. these can all be used alone, as single, sole plasticizers.

Preferably the film comprises a single plasticiser, being a polyol.

Preferably the polyol comprises a polyol having a low weight average molecular weight.

Preferably the polyol has a weight average molecular weight of no more than 400 Daltons, more preferably no more than 300 Daltons, more preferably no more than 200 Daltons, more preferably no more than 100 Daltons.

The polyol may comprise a diol or a triol or a tetrol, that is to say it may comprise one or two or three hydroxyl groups.

The polyol may comprise a monomeric or a polymeric polyol.

Exemplary plasticizers can include glycerol, diglycerol, sorbitol, ethylene glycol, diethylene glycol, triethylene glycol, dipropylene glycol, tetraethylene glycol, propylene glycol, polyethylene glycols having a molecular weight no more than (up to) 400 MW (weight average molecular weight), neopentyl glycol, trimethylolpropane, poly ether polyols, sorbitol, 2-methyl-1,3-propanediol (MPDiol(R)), ethanolamines, and a mixture thereof.

The plasticizer preferably excludes MHPC (methylhydroxypropyl).

The plasticizer preferably excludes gums e.g. locust bean gum.

The plasticizer preferably excludes polyvinyl alcohol (PVOH) plasticisers such as Preferably, the polyol comprises glycerol. Glycerol provides high elongation.

Preferably, the polyol comprises sorbitol.

Preferably the polyol comprises a polymeric polyol up to 400 weight average molecular weight (MW), such as polyethylene glycol (PEG) 400.

Multiple plasticisers can be included but preferably the film comprises a single plasticiser, being a polyol. The inventors have found that when any of glycerol, D-Sorbitol and PEG 400 are combined with carrageenan film, no additional plasticizers are needed, i.e. these can all be used alone, as single, sole plasticizers.

In the case of films comprising Iota or lamda carrageenan, preferably the plasticizer is a glycerol or PEG or D-sorbitol preferably PEG 400.

For Iota carrageenan films requiring high elongation, glycerol is highly preferred.

For lambda carrageenan Films requiring high elongation values Glycerol or PEG, preferably PEG-400 are preferred.

Preferably the film comprises from 1-99% wt, more preferably from 5-95% wt plasticiser based on total weight of dry e.g cast film.

Preferably the plasticiser e.g. polyol (single or blend) is present in the film at 20-80% wt, more preferably 40-60% wt of film, most preferably 50% wt, based on total dry wt. of the film. This is advantageous as stretchability (ultimate strain) means that the film can be stretched across deep recesses. At these levels, the films are also sufficiently strong to enable capsule formation with the film remaining intact.

### PVOH

The film may comprise polyvinyl alcohol (PVOH). The PVOH may be present at a maximum level of 50% wt, preferably at maximum of 25%, (% wt based on total dry (cast) weight of the film).

### Bittering Agent

The bittering agent is selected from: capsicinoids (including capsaicin); vanillyl ethyl ether; vanillyl propyl ether; vanillyl butyl ether; vanillin propylene; glycol acetal; ethylvanillin propylene glycol acetal; capsaicin; gingerol; 4-(1-menthoxymethyl)-2-(3′-methoxy-4′-hydroxy-phenyl)-1,3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof.

Preferred bittering agents include capsaicinoids, which includes capsaicin, dihydrocapsaicin, nordihydrocapsaicin, homodihydrocapsaicin, homocapsaicin, and nonivamide. A particularly preferred bittering agent is capsaicin.

Bittering agents may also be selected from benzoic benzylamine amide, denatonium benzoate, denatonium saccharide, trichloroanisole, methyl anthranilate and quinine (and salts of quinine).

Further examples of bittering agents include naringin, sucrose octaacetate, and agents derived from plant or vegetable matter, such as chemical compounds derived from chilli pepper plants, those derived from a plant species of the genus cynaro, alkaloids and amino acids.

Preferably, the bittering agent is selected from the group consisting of denatonium benzoate, denatonium saccharide, quinine or a salt of quinine. The chemical name of denatonium is phenylmethyl-[2-[(2,6-dimethylphenyl)amino]-2-oxoethyl]-diethylammonium. In particular embodiments, the bittering agent is denatonium benzoate or denatonium saccharide.

The bittering agent may have a bitter value of between 1000 and 10,000,000 as measured using the standardized process is used that is set forth in the European Pharmacopoeia (5th Edition, Stuttgart 2005, Volume 1, General Monograph 15 Groups, 2.8.15 Bitterness Value, p. 278).

The bittering agent may be incorporated within the film or in a film-coating on the exterior surface of the film (prior to making the capsule) or water-soluble capsule. Preferably the bittering agent is incorporated into the film.

The bittering agent may be incorporated into the matrix of a water-soluble polymer included in the film by dissolving the bittering agent in a water-soluble polymer solution before the unprinted region of the film is formed. The bittering agent may be present in film material in a range of 100 to 5000 ppm, preferably 200 to 3000 ppm, more preferably 500 to 2000 ppm, based on the weights of the bittering agent and film. For example, 1 mg of bittering agent may be incorporated into 1 g of film to provide the bittering agent at 1000 ppm.

Additionally or alternatively, the bitter agent may be included in the water-soluble package as a powdered bittering agent in a powder coating applied to the exterior surface of the water-soluble package (described in more detail below)

Preferably, the water-soluble package includes a powder coating on an exterior surface of the film, and the powder coating includes a powdered lubricating agent. The powder coating, when present, may coat printed region or regions and/or unprinted region or regions (if present) of the film. In any printed regions of the film, the powder coating may be indirectly on the exterior surface of the film where there is a layer of dye or pigment. The powder coating may be applied to least 50%, preferably at least 60%, at least 70% even more preferably at least 80%, most preferably at least 90% percent by area of the exterior surface of the film. The powder coating can be applied by any known technique such as spray-coating or passing the film through a falling curtain of powder coating composition. The powder coating may be applied to the exterior surface of the film at a rate of 0.5 to 10 mg per 100 cm², in some embodiments not more than 5 mg per 100 cm², and in further embodiments in the range of 1.25 to 2.5 mg per 100 cm². The powder coating may be applied to or present on the exterior surface of the film in an amount of 100 ppm or more, preferably 200 ppm or more, more preferably 300 ppm or more, based on the weights of the powder coating and the film. For example, a 1 mg of powder coating may be applied to a 1 g film to provide a 1000 ppm coating on the substrate. In certain embodiments, the powder coating is applied to or present on the exterior surface of the film in a range of 100 to 5000 ppm, preferably 200 to 3000 ppm, more preferably 300 to 2000 ppm.

### Lubricating Agent

The powder coating may include a powdered lubricating agent. Typical powdered lubricating agents include oligosaccharide, polysaccharide and inorganic lubricating agents. The powdered coating may include one or more of the group selected from starch, modified starches (including, but limited to, corn starch, potato starch or hydroxyethyl starch) silicas, siloxanes, calcium carbonate, magnesium carbonate, clay, talc, silicic acid, kaolin, gypsum, zeolites, cyclodextrins, calcium stearate, zinc stearate, alumina, magnesium stearate, sodium sulfate, sodium citrate, sodium tripolyphosphate, potassium sulfate, potassium citrate, potassium tripolyphosphate and zinc oxide. In a preferred embodiment, the powdered lubricating agent includes talc.

The powder coating can include a bittering agent in addition to or as an alternative to a bittering agent being present within or film-coated on the film. The powdered bittering agent may be a powdered form of any one of the bittering agents described herein. When a bittering agent is included in a powder coating, the powdered bittering agent may form 5 weight percent or more of the powder coating based on the total weight of the powder coating. In some embodiments, the powdered bittering agent forms 10 weight percent or more, 15 weight percent or more, 20 weight percent or more, or 25 weight percent or more of powder coating based on the total weight of the powder coating. In some embodiments, the powdered bittering agent forms 75 weight percent or less, 70 weight percent or less, 65 weight percent or less, 60 weight percent or less, or 55 weight percent or less of the powder coating based on the total weight of the powder coating. In further embodiments, the powdered bittering agent forms 5 to 75 weight percent, 10 to 70 weight percent, 15 to 65 weight percent, 20 to 60 weight percent, or 25 to 55 weight percent of the powder coating based on the total weight of the powder coating. In alternative embodiments, the powdered bittering agent forms 50 weight percent or less, 40 weight percent or less, 30 weight percent or less of the powder coating based on the total weight of the powder coating. In these embodiments, it is advantageous to include a relatively low amount of powdered bittering agent in the powder coating while maintaining a bitter taste when a user tries to ingest the water-soluble package.

The powdered bittering agent, when present, may have an average particle diameter of at least about 0.1 microns. The powdered bittering agent may have an average particle diameter of about 200 microns or less. In some embodiments, the powdered bittering agent has an average particle diameter of in the range of about 0.1 to 100 microns, in other embodiments in the range of about 0.1 to 20 microns and in further embodiments in a range of about 5 and 15 microns. Average particle diameter can be measured by known optical imaging techniques.

In some embodiments, the powder coating further includes one or more additional active agents. The additional active agent may be selected from one or more of the group of enzymes, oils, odour absorbers, fragrances, bleaches, bleach components, cleaning polymers, soil release polymers, EPEI, water softeners, dyes and fabric softeners.

### Production

The capsules may be formed in any suitable manner using the water-soluble carrageenan film.

The film may be folded and/or sealed to create the at least one internal compartment with and internal space which can then be filled with a home care composition. Optionally the compartment is then closed by sealing the film e.g. around the periphery of the capsule.

Alternatively the water-soluble capsule may comprising a first film comprising a thermoformed recess, said recess containing a substrate treatment composition and a second film superposed over said first film, said first and second films sealed around the edges, wherein said first and second films are according to the first aspect of the invention and any preferred/optional features as described herein.

Packages comprising a film such as those described herein may be manufactured using a form fill seal approach or using a vacuum form, fill seal approach. Pouches may be formed on a continuously moving process where a film is drawn into a mould, filled from above and then sealed by application of a second film. The pouches are then separated from one another to form individual unit dose products.

Substrate treatment capsules e.g. laundry capsules maybe thermoformed which involves a moulding process to deform sheet film to provide recesses therein. The process involves heating sheet film to soften and deform the film to stretch and fill a cavity in a mould and also the application of vacuum. The recesses are filled and the capsules completed by overlaying a second sheet of film over the filled recesses and sealing it to the first sheet of film around the edges of the recesse to form a flat seal. Relaxation of the first film typically then causes the applied second sheet to bulge out when the vacuum is released from the first sheet of film in the mould. For high performance laundry or machine dish wash treatment capsules there is a need to fill the capsule with sufficient liquid. The fill volume results in a greater stretch imposed on the water-soluble and provides a capsule with a bulbous, convex outer profile as the first and second sheets bulge out and stretch under the pressure. Films need to be strong and sufficiently stretchy to allow for this process. Films according to the invention are advanatageous for thermoforming such capsules as they exhibit strength and stretch.

The two films may be heat or water sealed depending on the process machinery used.

The capsule may be sealed using a sealing solution which may comprise an aqueous solution e.g. polysaccharide glue. The glue preferably comprises dextran, cellulose derivatives, gums e.g. locust bean gum, or starch or starch derivatives. The film surface may be treated to provide an adhesion surface e.g. microperforations, abrasions, or acidification of the surface to provide acid-esterified carrageenan.

The water-soluble packages of the present invention can be manufactured using standard known techniques. The film may be printed, for example, a sheet of film (e.g. film) may be printed with one or more layers of dye or pigment in a pattern. The pattern may be indicia, such as words, symbols or drawings. The layer or layers of dye or pigment may be printed onto the film using an ink. The ink type is not particularly limited, and includes non-aqueous solvent-based inks (such as organic solvent-based inks), aqueous-based inks and/or UV cured inks. In some embodiments, the ink is a non-aqueous-based ink. The film may be printed with a primer layer before printing of the layer or layers of dye or pigment. After printing with the layer or layers of dye or pigment, the film may be printed with a protective or lacquer layer. The printed layer or layers may be then dried, for example using heat and/or air flow. The resulting printed film may be stored, transported or used immediately to form the printed water-soluble packages as described herein.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either side of the film.

When the bittering agent is contained within at least part of the film, the bittering agent is typically present in the film before printing. In one embodiment, the bittering agent is included at least on part of the exterior surface of the film as a film coating. The film coating of bittering agent may be deposited on the water-substrate before, during or after the printing of the printed regions.

The film is typically formed (preferably thermoformed) into a film enclosure (e.g. a film pocket, open capsule or container). The film enclosure may then be filled with a composition such as a dishwashing or laundry detergent composition. The water-soluble enclosure containing the composition or material can then be sealed, for example by sealing the edges of the enclosure or joining the enclosure with one or more additional pieces of film, in order to enclose the material or composition in the water-soluble package. The powder coating may then be applied to the exterior surface of the film. The powder coating may be applied to the film by any known powder technique. Preferably, the powder is applied to the film using no solvent or a non-aqueous solvent. Such an application reduces the risk of dissolving the film. The above optional and preferred features are equally combinable and applicable to all aspects of the invention, unless indicated otherwise.

In a particular embodiment, the present invention provides a printed water-soluble package comprising a film of the first aspect, the film enclosing a composition, the film having an exterior surface with one or more printed regions, the bittering agent is selected from the group consisting of denatonium benzoate, denatonium saccharide, quinine or a salt of quinine and is substantially homogenously contained within the film, and wherein the water-soluble package further includes a powder coating coated on the exterior surface of the film, the powder coating a including a powdered lubricating agent, the powdered lubricating agent being talc.

### Liquid Laundry Detergent Composition

The substrate composition may be in the form of a solid, a liquid, a dispersion, a gel, a paste, a fluid or a mixture thereof. The capsule preferably comprises a liquid composition.

Non-limiting examples of compositions include cleaning compositions, fabric care compositions, automatic dishwashing compositions and hard surface cleaners. More particularly, the compositions may be a laundry, fabric care or dish washing composition including, pre-treatment or soaking compositions and other rinse additive compositions. The laundry detergent composition may be used during the main wash process or could be used as pre-treatment or soaking compositions.

The water-soluble capsule preferably comprises a laundry detergent composition. The liquid composition may be opaque, transparent or translucent.

The or each compartment may comprise the same or a different composition., however, it may also comprise different compositions in different compartments. The composition may be any suitable composition.

Laundry detergent compositions include fabric detergents, fabric softeners, 2-in-1 detergent and softening, pre-treatment compositions and the like. Laundry detergent compositions may comprise surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, processing aids and/or pigments and mixtures thereof. The composition may be a laundry detergent composition comprising an ingredient selected from the group comprising a shading dye, surfactant, polymers, perfumes, encapsulated perfume materials, structurant and mixtures thereof.

The liquid laundry detergent composition may comprise an ingredient selected from, bleach, bleach catalyst, dye, hueing dye, cleaning polymers including alkoxylated polyamines and polyethyleneimines, soil release polymer, surfactant, solvent, dye transfer inhibitors, chelant, enzyme, perfume, encapsulated perfume, polycarboxylates, structurant and mixtures thereof.

Surfactants can be selected from anionic, cationic, zwitterionic, non-ionic, amphoteric or mixtures thereof. Preferably, the fabric care composition comprises anionic, non-ionic or mixtures thereof.

The anionic surfactant may be selected from linear alkyl benzene sulfonate, alkyl ethoxylate sulphate and combinations thereof.

Suitable anionic surfactants useful herein can comprise any of the conventional anionic surfactant types typically used in liquid detergent products. These include the alkyl benzene sulfonic acids and their salts as well as alkoxylated or non-alkoxylated alkyl sulfate materials.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. In one aspect, R¹ is an alkyl group, which may be primary or secondary, that comprises from about 9 to 15 carbon atoms, or from about 10 to 14 carbon atoms. In one aspect, the alkoxylated fatty alcohols will also be ethoxylated materials that contain on average from about 2 to 12 ethylene oxide moieties per molecule, or from about 3 to 10 ethylene oxide moieties per molecule.

The shading dyes employed in the present laundry detergent compositions may comprise polymeric or non-polymeric dyes, pigments, or mixtures thereof. Preferably the shading dye comprises a polymeric dye, comprising a chromophore constituent and a polymeric constituent. The chromophore constituent is characterized in that it absorbs light in the wavelength range of blue, red, violet, purple, or combinations thereof upon exposure to light. In one aspect, the chromophore constituent exhibits an absorbance spectrum maximum from about 520 nanometers to about 640 nanometers in water and/or methanol, and in another aspect, from about 560 nanometers to about 610 nanometers in water and/or methanol.

Although any suitable chromophore may be used, the dye chromophore is preferably selected from benzodifuranes, methine, triphenylmethanes, napthalimides, pyrazole, napthoquinone, anthraquinone, azo, oxazine, azine, xanthene, triphenodioxazine and phthalocyanine dye chromophores. Mono and di-azo dye chromophores are preferred. The shading dye may comprise a dye polymer comprising a chromophore covalently bound to one or more of at least three consecutive repeat units. It should be understood that the repeat units themselves do not need to comprise a chromophore. The dye polymer may comprise at least 5, or at least 10, or even at least 20 consecutive repeat units.

The repeat unit can be derived from an organic ester such as phenyl dicarboxylate in combination with an oxyalkyleneoxy and a polyoxyalkyleneoxy. Repeat units can be derived from alkenes, epoxides, aziridine, carbohydrate including the units that comprise modified celluloses such as hydroxyalkylcellulose; hydroxypropyl cellulose; hydroxypropyl methylcellulose; hydroxybutyl cellulose; and, hydroxybutyl methylcellulose or mixtures thereof. The repeat units may be derived from alkenes, or epoxides or mixtures thereof. The repeat units may be C2-C4 alkyleneoxy groups, sometimes called alkoxy groups, preferably derived from C2-C4 alkylene oxide. The repeat units may be C2-C4 alkoxy groups, preferably ethoxy groups.

For the purposes of the present invention, the at least three consecutive repeat units form a polymeric constituent. The polymeric constituent may be covalently bound to the chromophore group, directly or indirectly via a linking group. Examples of suitable polymeric constituents include polyoxyalkylene chains having multiple repeating units. In one aspect, the polymeric constituents include polyoxyalkylene chains having from 2 to about 30 repeating units, from 2 to about 20 repeating units, from 2 to about 10 repeating units or even from about 3 or 4 to about 6 repeating units. Non-limiting examples of polyoxyalkylene chains include ethylene oxide, propylene oxide, glycidol oxide, butylene oxide and mixtures thereof.

The dye may be introduced into the detergent composition in the form of the unpurified mixture that is the direct result of an organic synthesis route. In addition to the dye polymer therefore, there may also be present minor amounts of un-reacted starting materials, products of side reactions and mixtures of the dye polymers comprising different chain lengths of the repeating units, as would be expected to result from any polymerisation step.

The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, beta-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

The laundry detergent compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1 percent to about 50 percent or even from about 0.1 percent to about 25 percent bleaching agent by weight of the subject cleaning composition.

The composition may comprise a brightener. Suitable brighteners are stilbenes, such as brightener 15. Other suitable brighteners are hydrophobic brighteners, and brightener 49. The brightener may be in micronized particulate form, having a weight average particle size in the range of from 3 to 30 micrometers, or from 3 micrometers to 20 micrometers, or from 3 to 10 micrometers. The brightener can be alpha or beta crystalline form.

The compositions herein may also optionally contain one or more copper, iron and/or manganese chelating agents. If utilized, chelating agents will generally comprise from about 0.1 percent by weight of the compositions herein to about 15 percent, or even from about 3.0 percent to about 15 percent by weight of the compositions herein.

The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001 percent, from about 0.01 percent, from about 0.05 percent by weight of the cleaning compositions to about 10 percent, about 2 percent, or even about 1 percent by weight of the cleaning compositions.

The laundry detergent composition may comprise one or more polymers. Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.

Other suitable cellulosic polymers may have a degree of substitution (DS) of from 0.01 to 0.99 and a degree of blockiness (DB) such that either DS+DB is of at least 1.00 or DB+2DS-DS² is at least 1.20. The substituted cellulosic polymer can have a degree of substitution (DS) of at least 0.55. The substituted cellulosic polymer can have a degree of blockiness (DB) of at least 0.35. The substituted cellulosic polymer can have a DS+DB, of from 1.05 to 2.00. A suitable substituted cellulosic polymer is carboxymethylcellulose. Another suitable cellulosic polymer is cationically modified hydroxyethyl cellulose. Suitable perfumes include perfume microcapsules, polymer assisted perfume delivery systems including Schiff base perfume/polymer complexes, starch-encapsulated perfume accords, perfume-loaded zeolites, blooming perfume accords, and any combination thereof. A suitable perfume microcapsule is melamine formaldehyde based, typically comprising perfume that is encapsulated by a shell comprising melamine formaldehyde. It may be highly suitable for such perfume microcapsules to comprise cationic and/or cationic precursor material in the shell, such as polyvinyl formamide (PVF) and/or cationically modified hydroxyethyl cellulose (catHEC).

Suitable suds suppressors include silicone and/or fatty acid such as stearic acid. The liquid laundry detergent composition maybe coloured. The colour of the liquid laundry detergent composition may be the same or different to any printed area on the film of the article. Each compartment of the unit dose article may have a different colour. Preferably, the liquid laundry detergent composition comprises a non-substantive dye having an average degree of alkoxylation of at least 16.

At least one compartment of the unit dose article may comprise a solid. If present, the solid may be present at a concentration of at least 5 percent by weight of the unit dose article.

The second water-soluble film may comprise at least one open or closed compartment. In one embodiment, a first web of open pouches is combined with a second web of closed pouches preferably wherein the first and second webs are brought together and sealed together via a suitable means, and preferably wherein the second web is a rotating drum set-up. In such a set-up, pouches are filled at the top of the drum and preferably sealed afterwards with a layer of film, the closed pouches come down to meet the first web of pouches, preferably open pouches, formed preferably on a horizontal forming surface. It has been found especially suitable to place the rotating drum unit above the horizontal forming surface unit.

Preferably, the resultant web of closed pouches are cut to produce individual unit dose articles.

Those skilled in the art would recognize the appropriate size of mould needed in order to make a unit dose article according to the present invention.

When carrying or containing a substrate treatment composition, this may be a laundry treatment composition such as a laundry liquid or powder composition. Such formulations are well known in the art and comprise water up to around 15% wt. of the composition; surfactants such as anionic surfactants, non-ionic surfactants, zwitterionic surfactants and mixtures thereof. Further, polymeric cleaning aids such as soil release polymers and polyamines are commonly employed to improve cleaning performance. Fragrances are added for providing a fragrance benefit to the fabric after treatment.

Visual cues such as dyes are used to provide improved aesthetics.

### Combinations of Aspects

A number of proposals and aspects are described herein, which proposals and aspects are intended to be combined to achieve improved or cumulative benefits. Thus, any one aspect may be combined with any other aspect. Similarly the optional features associated with any one of the aspects may apply to any one of the other aspects.

### EXAMPLES

### Carrageenan Film Tests

TABLE 1
Carrageen Film Compositions

| | CGN | | Plasticiser | | Average |
|---|---|---|---|---|---|
| | | Level | | Level | Thickness |
| CGN Film Code | Type | (wt %) | Type | (wt %) | (μm) |
| 50:50 (Iota PS50 CGN: D-Sorbitol) | Iota | 50 | D-Sorbitol | 50 | 86 |
| 50:50 (Iota PS50 CGN: PEG400) | PS50 | | PEG400 | | 89 |
| 50:50 (Iota PS50 CGN: Glycerol) | | | Glycerol | | 63 |
| 50:50 (Lambda CS50 CGN: D- | Lambda | | D-Sorbitol | | 88 |
| Sorbitol) | CS50 | | | | |
| 50:50 (Lambda CS50 CGN: PEG400) | | | PEG400 | | 98 |
| 50:50 (Lambda CS50CGN: Glycerol) | | | Glycerol | | 98 |

### Method for Making the Carrageenan Film

### Preparation of Polymer Solutions to Cast Films

1. Film components were mixed with water to provide a casting solution in a ratio of 7.5% wt. film to 92.5% wt. water as follows.
2. Carageenan was dissolved in hot water (70-80C) with overhead stirrer (added gradually) then left for approx. 5-10 minutes to dissolve and plasticiser (glycerol, PEG400 or D-sorbitol) added—in ratios according to the table.
3. The solution was left to stir for approximately 15 minutes until full dissolution and mixing, ensuring the stirrer was fully immersed to avoid formation of bubbles.
4. The mixture was then centrifuged for 20 minutes at 2800 rpm at 30C to degas and remove bubbles.
5. The total solution weighed 100 g and is sufficient to cast a film the size of an A4 sheet. The casting solution should be at 40C when casting the films.

### Casting

1. Films were cast on to a teflon substrate using a Elcometer 4340 Motorised/Automatic Film Applicator and Elcometer 3570 Micrometric Film Applicators.
2. The casting knife was set at different thickness (for clarity this is the thickness of the cast solution or wet film, before the film has set and water evaporated from the solution).
3. The optimum casting thickness for an 7.5 wt % casting solutions is 2000 μm to give a dry film thickness of 85 μm. Thicknesses were varied.
4. Casting speed 2 (1 m per minute) was used and this advantageously reduces bubbles.
5. Any bubbles observed can be popped e.g. with a sharp spatula.
6. The films were dried in ambient laboratory conditions for 12-48 hours (the time depends on ambient conditions) and then tested for peeling from the substrate. For increased drying speed, films can be dried in an oven at 50° C. for 3 hours.

### Ultimate Stress and Strain Analysis.

### Method of Measuring Strain and Stress.

Film samples of varying thickness were subjected to tensile: stress and strain tests using an Instron model 5566. For these tensile studies, strain is the elongation before break and the stress is the force applied before break. We used a 100N load cell on film strips 12 cm×2.5 cm, following ASTM D882 and we use a speed rate of maximum 8 mm per second. This method is a standard test method for analysing the tensile characteristics of thin plastic sheeting. In this test, the plastic sheet is pulled until it breaks for measuring the elongation, tensile yield strength, tensile modulus, and tensile strength at break, and is specifically designed for films of less than 1 mm in thickness.

Ultimate strain gives an indication of how much a film can stretch. For certain products, such as formed capsules, sheet film needs to stretch/deform so it can form a 3-D shape. For a rounded, hemispherical deformation the film needs to stretch by about 40% (to a total of 140%). Such a recess allows sufficient (for performance) levels of substrate composition. However, the film must also be sufficiently strong not to break as it stretches. Therefore ultimate stress is also important, to ensure the strength of a film (under tension). At the same time, the film must not be too thick as this can slow down dissolution. Both strength and stretch in a thin film are needed for a film to be a viable manufacturing material.

TABLE 2
Film Ultimate Strain and Stress Test Results.

| | | | | | | Average | | Average | |
|---|---|---|---|---|---|---|---|---|---|
| | CGN | | Plasticiser | | Average | Ultimate | | Ultimate | |
| | | Level | | Level | Thickness | Strain | SD | Stress | SD |
| CGN Film Code | Type | (wt %) | Type | (wt %) | (μm) | (%) | (%) | (MPa) | (%) |
| 50:50 (Iota PS50 | Iota | 50 | D-Sorbitol | 50 | 86 | 61.9 | 8.9 | 18.7 | 3.2 |
| CGN:D-Sorbitol) | PS50 | | | | | | | | |
| 50:50 (Iota PS50 | | | PEG400 | | 89 | 68.2 | 5.3 | 21.5 | 1.8 |
| CGN:PEG400) | | | | | | | | | |
| 50:50 (Iota PS50 | | | Glycerol | | 63 | 107.5 | 5.1 | 20.7 | 3.2 |
| CGN:Glycerol) | | | | | | | | | |
| 50:50 (Lambda CS50 | Lambda | | D-Sorbitol | | 88 | 79.1 | 10.0 | 9.7 | 1.4 |
| CGN:D-Sorbitol) | CS50 | | | | | | | | |
| 50:50 (Lambda CS50 | | | PEG400 | | 98 | 100.6 | 6.2 | 6.3 | 0.6 |
| CGN:PEG400) | | | | | | | | | |
| 50:50 (Lambda | | | Glycerol | | 98 | 95.4 | 4.4 | 13.4 | 1.2 |
| CS50CGN:Glycerol) | | | | | | | | | |

The data shows that carrageenan films exhibit advantageous extensibility and strength with various plasticizers.

### Pectin Films

Exemplary films were made with varying ratios of Pectin, surfactants (suganate) and glycerol as in the Table 1 below.

TABLE 3
Film Compositions

| | Pectin | Glycerol | Surfactant: Suganate | |
|---|---|---|---|---|
| | (wt %) | (wt %) | (wt %) | |
| Film | in film | in film | in film | Suganate type |
| 7:2:1 100NC | 70 | 20 | 10 | 100NC |
| 7:2:1 160NC | | | | 160NC |
| 7:2:1 poly | | | | polysuganate |
| 6:1:3 100NC | 60 | 10 | 30 | 100NC |
| 6:1:3 160NC | | | | 160NC |
| 6:1:3 poly | | | | polysuganate |
| 6:2:2 100NC | 60 | 20 | 20 | 100NC |
| 6:2:2 160NC | | | | 160NC |
| 6:2:2 poly | | | | polysuganate |
| 6:3:1 100NC | 60 | 30 | 10 | 100NC |
| 6:3:1 160NC | | | | 160NC |
| 6:3:1 Poly | | | | polysuganate |
| 6:2:2 poly | 60 | 20 | 20 | polysuganate |
| Bitrex | | | | |

Pectin: Aglupectin LA-S20 from Silvateam, via Torre, 7, 12080 San Michele Mondovi CN-Italy Glycerol (95% conc.)

### Surfactants:

Suganate type “100NC” is Suga®Nate 100NC, available from Colonial Chemical, Inc., located in South Pittsburgh, TN (CAS NUMBER 742087-48-5).
Suganate type “160NC” is Suga®Nate 160NC, available from Colonial Chemical, Inc., located in South Pittsburgh, TN (CAS NUMBER 742087-49-6).
Suganate type “poly” is Poly Suga®Nate 160P (primarily C12 poly sulfonate functionalized alkyl polyglucoside), available from Colonial Chemical, Inc., located in South Pittsburgh, TN.

### Method for Making the Pectin Film Compositions of Table 3.

### Preparation of Polymer Solutions to Cast Films

Film components were mixed with water to provide a casting solution in a ratio of 18% wt. film to 82% wt. water as follows.
6. Pectin was dissolved in boiling water with overhead stirrer (added gradually) then left for approx. 5-10 minutes to dissolve and glycerine added—in ratios according to the table.
7. Three types of anionic surfactant (100NC, 160NC or poly) were used as shown in Table 3)
8. The solution was left to stir for approximately 5 minutes until full dissolution and mixing, ensuring the stirrer was fully immersed to avoid formation of bubbles.
9. The mixture was then centrifuged for 100 minutes at 6000 rpm to degas and remove bubbles.
10. The total solution weighed 45 g and is sufficient to cast a film the size of an A4 sheet

### Casting

7. Films were cast on to a polyacrylate substrate using a Elcometer 4340 Motorised/Automatic Film Applicator and Elcometer 3570 Micrometric Film Applicators.
8. The casting knife was set at different thickness (for clarity this is the thickness of the cast solution or wet film, before the film has set and water evaporated from the solution).
9. The optimum speed for an 18 wt % casting solutions is 800 μm to give a dry film thickness of 80 μm. Thicknesses were varied.
10. Casting speed 3 (1.2 m per minute) was used and this advantageously reduces bubbles.
11. Any bubbles observed can be popped e.g. with a sharp spatula.
12. The films were dried in ambient laboratory conditions for 12-48 hours (the time depends on ambient conditions) and then tested for peeling from the substrate. For increased drying speed, films can be dried in an oven at 40° C. for 2 hours.

### Ultimate Stress and Strain Analysis.

### Method of Measuring Strain and Stress.

Film samples of varying thickness were subjected to tensile: stress and strain tests using an Instron model 5566. For these tensile studies, strain is the elongation before break and the stress is the force applied before break. We used a 100N load cell on film strips 12 cm×2.5 cm, following ASTM D882 and we use a speed rate of maximum 8 mm per second. This method is a standard test method for analysing the tensile characteristics of thin plastic sheeting. In this test, the plastic sheet is pulled until it breaks for measuring the elongation, tensile yield strength, tensile modulus, and tensile strength at break, and is specifically designed for films of less than 1 mm in thickness.

Ultimate strain gives an indication of how much a film can stretch. For certain products, such as formed capsules, sheet film needs to stretch/deform so it can form a 3-D shape. For a rounded, hemispherical deformation the film needs to stretch by about 40% (to a total of 140%). Such a recess allows sufficient (for performance) levels of substrate composition. However, the film must also be sufficiently strong not to break as it stretches. Therefore ultimate stress is also important, to ensure the strength of a film (under tension). At the same time, the film must not be too thick as this can slow down dissolution. Both strength and stretch in a thin film are needed for a film to be a viable manufacturing material.

### Film Ultimate Strain and Stress Test Results

All films were also sufficiently strong to enable capsule formation with the film in tact. The stress (i.e.) the strength of the capsules was maintained with the inclusion of the surfactant.

| | Ultimate | | Ultimate | |
|---|---|---|---|---|
| | Strain | | Stress | |
| | (%) | SD | (MPa) | SD |
| 6:1:3 100NC | 34.78 | 5.40 | 5.30 | 0.50 |
| 6:2:2 100NC | 43.51 | 8.30 | 7.20 | 1.20 |
| 6:2:2 160NC | 47.10 | 2.76 | 7.70 | 1.40 |
| 6:2:2 Polysuganate | 38.06 | 5.50 | 8.20 | 1.05 |
| 6:3:1 100NC | 38.98 | 2.40 | 8.60 | 0.40 |
| 6:3:1 160NC | 29.90 | 1.88 | 11.02 | 0.95 |
| 6:3:1 Polysuganate | 32.71 | 2.81 | 12.01 | 0.99 |
| 7:2:1 100NC | 31.25 | 5.10 | 14.82 | 1.98 |
| 7:2:1 160NC | 35.27 | 3.90 | 12.30 | 1.10 |
| 7:2:1 Polysuganate | 34.46 | 2.60 | 12.00 | 0.90 |

### Pectin Film Dissolution Tests

Film pieces were cut to the size 4 cm×2.5 cm were dissolved in 150 mL of demineralised water at 40° C. in a 250 mL beaker stirring at 150 rpm and recorded time until total film dissolution.

| | Mean | |
|---|---|---|
| Film | (seconds) | STD |
| 6:1:3 100NC | 901 | 142.17 |
| 6:2:2 100NC | 933 | 295.34 |
| 6:2:2 160NC | 904 | 293.4 |
| 6:2:2 Polysuganate | 770 | 292.4 |
| 6:3:1 100NC | 589 | 226.30 |
| 6:3:1 160NC | 1281 | 192 |
| 6:3:1 Polysuganate | 970 | 269.2 |
| 7:2:1 100NC | 716 | 206.48 |
| 7:2:1 160NC | 717 | 175.89 |
| 7:2:1 Polysuganate | 563 | 213.20 |

### Methods of Making the Capsules Containing a Substrate Treatment Formulation.

Two sheets of the film were prepared as described above. The sheets can be sealed around the edges (except for one edge) to form an open package, the package filled with a substrate treatment composition, and then the edge sealed. This forms a simple pillow-shaped package.

In another method, the capsule is produced by a process of thermoforming:
(a) the first sheet of water-soluble polyvinyl alcohol film was placed over a mould having a cavity;
(b) the cavity is heated and also a vacuum applied to the film to mould the film into the cavities and hold it in place to form a corresponding recess in the film;
(c) the recess is then filled with a substrate treatment composition;
(d) the second sheet of film is superposed over the first sheet of film across the formed recess and sealed around the edge to produce a capsule having a compartment bounded by a continuous seal (referred to as a sealing web);
(e) the capsule is trimmed to remove excess sheet.

Relaxation of the first film typically then causes the applied second sheet to bulge out when the vacuum is released from the first sheet of film in the mould. Where mulitple capsules are made from a single sheet (which may be fed from a roll) the film is cut between the capsules so that a series of capsules are formed.

Sealing can be done by any suitable method for example heat-sealing, solvent sealing or UV sealing or ultra-sound sealing or any combination thereof. Particularly preferred is water-sealing. Water sealing may be carried out by applying water/moisture to the second sheet of film before it is sealed to the first sheet of film to form the seal areas.

### Liquid Capsules Dissolution Tests

Capsules are made according to the above example 5, filled with a commercially available laundry detergent composition. The capsules are tested for dissolution.
1. Add 4.5 litres of demineralised water into a 5-litre beaker at
2. Heat up the water to 30° C.
3. Place the beaker on the magnetic stirrer plate and add a large magnetic stirrer
4. Turn on the magnetic stirrer so that the vortex is 3 cm in depth
5. Place the capsule in the centre of the open holed net, gather the net up above the capsule and fasten with an elastic band (the capsule is held in a net to simulate the capsule being held in-between fabrics and it allows the water to flow through the net)
6. Clamp the stirrer paddle with the capsule in a net attached above the beaker
7. Lower the net into the water up to the mark indicated on the paddle and start the clock immediately
8. Time how long it takes for the capsule to dissolve by noting the following: Bubble from liquid, Liquid leaking time, Liquid gone, film dissolved.

All capsules dissolve in the target range 30 s-30 mins releasing the formulation into the water.

### Example Capsule—Laundry Treatment Composition

The water soluble capsules comprise laundry treatment compositions dispensed to each of the three compartments is as follows:

| Compartment #1 | Compartment #2 | Side compartment #2 |
|---|---|---|
| Surfactant | Surfactants | Surfactants |
| Polymer cleaning | Polymer cleaning | Polymer cleaning |
| Sequestrant | Sequestrant | Sequestrant |
| Water | Enzyme - cellulase | Enzyme - protease |
| Hydroptrope | Fluorescer | Water 8% wt. |
| Opacifier | Water 8% wt | Hydrotrope |
| | Hydrotrope | Dyes |
| | Dyes | |
| | Perfume | |

The unit dosed products comprise water soluble film printed on the inside.

Further example formulations of unit dose products are provided below.

DESCRIPTION

| | 1 | 2 |
|---|---|---|
| | Inclusion | Inclusion |
| | level as | level as |
| Raw Material | 100% | 100% |
| SURFACTANT | | |
| LAS/SLES/NI ratio | 58/30/12 | 47/0/53 |
| LAS acid | 25.20 | 21.22 |
| SLES 3EO | 13.00 | |
| MIPA-LES 2EO | | |
| Non Ionic 7EO | 5.60 | 23.50 |
| Fatty acid/Oleic acid | 6.60 | 8.64 |
| HYDROTOPE | | |
| Glycerol | 7.70 | 13.10 |
| Mono Propyl Glycerol | 12.80 | 8.30 |
| NEUTRALIZER/BUFFER | | |
| MEA | 10.50 | 6.50 |
| WHITENESS AGENT | | |
| CBS-CL | 0.39 | 0.40 |
| SALTS & SEQUESTRANTS | | |
| & BUILDERS | | |
| Dequest 2010 | 2.90 | |
| Dequest 2066 | | 0.65 |
| Citric Acid | 0.70 | |
| Enzymes | | |
| Mannanase (% as Mannaway 4L) | 1.00 | 1.00 |
| Cellulase (% as Celluclean4500T) | 1.00 | 1.00 |
| Protease (% as Savinase ultra 16L) | 1.00 | 1.00 |
| Amylase (% as Stainzyme 12L) | 1.00 | 1.00 |

The unit dosed products comprise water soluble film.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the scope of the invention.

1. A water-soluble film comprising a polysaccharide having:
(i) a weight average molecular weight in the range 100K-1000K g/mol;
(ii) one or more functional groups comprising one or more of a sulfate, sulfonate or a carboxylate group or any combination thereof; and
wherein branching side chains comprising four or more units are present at a maximum of one side chain for every four units of the backbone; and
wherein the film thickness is from 40 to 200 micrometres.

2. A water-soluble film according to claim 1 wherein the weight average molecular weight is in the range 100K-300K g/mol.

3. A water-soluble film according to claim 1, wherein the weight average molecular weight is in the range 300K-1000K g/mol.

4. A water-soluble film according to claim 1, wherein the polysaccharide comprises at least 1 of said functional groups per repeating unit of the polysaccharide.

5. A water-soluble film according to claim 1, wherein the polysaccharide comprises no more than 5 of said functional groups per repeating unit.

6. A water-soluble film according to claim 1 said functional groups are linked by ester bonds to sugar moities, e.g. to hydroxyl groups of the sugar units of the polysaccharides.

7. A water-soluble film according to claim 1 wherein the polysaccharide is amidated.

8. A water-soluble film according to claim 1, wherein the degree of amidation (DA), as expressed as a percentage of amidated repeating units to total repeating units in the polysaccharide is from 2% to 25%.

9. A water-soluble film according to claim 1, comprising any one of pectin, carrageenan, alginate, chitsoan or any combination thereof.

10. A water-soluble film according to claim 1, wherein the film comprises polyvinyl alcohol (PVOH) at a maximum level of 50% wt % wt based on total dry weight of the film.

11. A water-soluble film according to claim 1, comprising at least one plasticiser.

12. A water-soluble film according to claim 1, comprising a surfactant.

13. A water-soluble film according to claim 1, comprising a bittering agent.

14. A water-soluble capsule comprising a water-soluble film, and at least one internal compartment enclosed by the water-soluble film, the compartment having an internal space and containing a home care composition within the internal space, where film is according to claim 1.

15. A method of making a water-soluble capsule, the method comprising the steps of
(i) thermoforming a first film of to provide a thermoformed recess in said first film;
(ii) filling said recess with a home care composition;
(iii) superposing a second film over said first film
(iv) sealing said first film to said second film sealed around edge regions of the films;
wherein the at least the first or second film comprises a polysaccharide having:
(i) a weight average molecular weight in the range 100K-1000K g/mol;
(ii) one or more functional groups comprising one or more of a sulfate, sulfonate or a carboxylate group or any combination thereof; and
wherein branching side chains comprising four or more units are present at a maximum of one side chain for every four units of the backbone; and
wherein the film thickness is from 40 to 200 micrometres.
